(19) United States
(12) Patent Application Publication
(10) Pub. No.: US 2023/0114510 A1
(43) Pub. Date: Apr. 13, 2023

(54) SHOPPING SERVICE MEDIATION SYSTEM

(71) Applicant: TOYOTA JIDOSHA KABUSHIKI KAISHA, Toyota-shi Aichi-ken (JP)

(72) Inventors: Kiyoto SASAKI, Susono-shi Shizuoka-ken (JP); Makoto KAWAHARADA, Susono-shi Shizuoka-ken (JP); Satoshi NAKAMURA, Susono-shi Shizuoka-ken (JP); Kenichi OKUMURA, Gotemba-shi Shizuoka-ken (JP); Naotoshi KADOTANI, Sunto-gun Shizuoka (JP)

(73) Assignee: TOYOTA JIDOSHA KABUSHIKI KAISHA, Toyota-shi Aichi-ken (JP)

(21) Appl. No.: 17/962,880

(22) Filed: Oct. 10, 2022

(30) Foreign Application Priority Data
Oct. 13, 2021 (JP) 2021-168032

(51) Int. Cl. G06Q 30/06

(52) U.S. Cl. CPC G06Q 30/0617

(57) ABSTRACT

A shopping service mediation system includes: a request distribution unit configured to distribute a request from a terminal apparatus related to a consignor who wishes to be entrusted, to other terminal apparatuses; an acceptance receiving unit configured to receive acceptances transmitted from the terminal apparatuses related to consignment applicants in response to the request; a determination unit configured to determine a formal consignee from the consignment applicants related to the terminal apparatuses each having transmitted the acceptance; and a confirmation unit configured to confirm completion of the shopping service, wherein each user's use tendency based on the number of entrustments and the number of times entrusted can be displayed on the terminal apparatus corresponding to the user.

### CROSS-REFERENCE TO RELATED APPLICATIONS

This application is based upon and claims the benefit of priority of the prior Japanese Patent Application No. 2021-168032, filed on Oct. 13, 2021, the entire contents of which are incorporated herein by reference.

### BACKGROUND

### 1. Technical Field

Embodiments of the present disclosure relate to a shopping service mediation system for mediating or supporting shopping service between a consignor (or a client) who entrusts the shopping service and a consignee who is entrusted with the shopping service.

### 2. Description of the Related Art

For this type of system, for example, there is proposed a shopping service system for matching a user and an assistant, so that the assistant goes shopping for the user in response to the user's request (see JP2019-139776A as Patent Literature 1). According to this system, shopping service is available without intervention of an agency and without payment or money transaction. Although there are further proposed systems for mediating a shopping service agency via an intermediary, or through payment or money transaction (see JP2002-183496A as Patent Literature 2 and JP2019-049794A as Patent Literature 3), the systems do not make for uses, a mutual assistance nor a reduction in economic burden.

According to the Patent Literature 1, however, in the real society, there are many parents who are raising children and those who wish to go shopping but cannot do so freely, and thus, on the system, the number of registered assistants who volunteer to perform the shopping service is less than the number of registered users who wish to go shopping or who wish to use the shopping service. This has a technical problem that a matching process does not function satisfactorily. That is, for example, a technology/technique thereof is not sufficient enough to strike a balance between the number of users and the number of assistants to be matched on data by building on the system an interdependency relationship between the users and the assistants.

### SUMMARY

In view of the problems described above, it is therefore an object of embodiments of the present disclosure to provide a shopping service mediation system capable of leading to fairness between use and assistance.

The above object of embodiments of the present disclosure can be achieved by a shopping service mediation system that mediates shopping service between a consignor who entrusts the shopping service and a consignee who is entrusted with the shopping service, the shopping mediation system including terminal apparatuses corresponding to a plurality of users respectively and comprising: user information management unit configured to manage user information that is information with respect to each of the plurality of users that can be at least one of the consignor and the consignee; a request distribution unit configured to distribute a request from the terminal apparatus related to a user as the consignor out of the plurality of users, to the terminal apparatuses related to users other than the consignor out of the plurality of users; an acceptance receiving unit configured to receive at least one acceptance, the acceptance indicating a desire to be entrusted with the shopping service, and having being transmitted from the terminal apparatus in response to the request distributed; a determination unit configured to determine a formal consignee from the users related to the terminal apparatuses each having transmitted the acceptance; and a confirmation unit configured to confirm completion of the shopping service by the formal consignee, wherein the user information management unit is configured to update a number of entrustments included in the user information with respect to the consignor and to update a number of times entrusted included in the user information with respect to the formal consignee when the completion of the shopping service is confirmed by the confirmation unit, and the user information management unit is further configured to display each user's use tendency based on the number of entrustments and the number of times entrusted, on the terminal apparatus corresponding to the user.

According to the shopping service mediation system in an aspect of embodiments of the present disclosure, by visualizing to the plurality of users, the number of entrustments and the number of times entrusted with respect to the past shopping service, directly (i.e., the number itself) or indirectly (i.e., not the number itself, but an index indicating its magnitude correlation, extent, or level), it is possible to lead to balance between the number of entrustments and the number of times entrusted with respect to an individual user, or lead to fairness between service use and assistance, even in an environment where the shopping service is provided for free. In particular, it is effective in an environment where there is no payment or money transaction of a usage fee. In addition, it is possible to fill an imbalance between the service use and the assistance with economic value, by granting a privilege to a person who assists often or charging a system usage fee to a person who entrusts the shopping service often.

Such operations and effects according to the present disclosure will be more apparent by DETAILED DESCRIPTION OF THE EMBODIMENT described below.

### BRIEF DESCRIPTION OF THE DRAWINGS

FIG. 1 is a block diagram illustrating an example of an overall configuration of a shopping service mediation system according to a first embodiment;

FIG. 2 is a diagram illustrating an example of a hardware configuration of a management server in the shopping service mediation system according to the first embodiment;

FIG. 3 is a diagram illustrating an example of a data configuration of various kinds of information used in the shopping service mediation system according to the first embodiment;

FIG. 4 is a diagram illustrating an example of a hardware configuration of a terminal apparatus in the shopping service mediation system according to the first embodiment;

FIG. 5 is a flowchart illustrating an example of a processing routine related to shopping service mediation performed by the shopping service mediation system according to the first embodiment;

FIG. 6 is a sequence diagram illustrating an example of a service entrustment process performed by the shopping service mediation system according to the first embodiment;

FIG. 7 is a diagram illustrating an example of a request screen displayed on the terminal apparatus in the service entrustment process;

FIG. 8 is a diagram of the same subject as that in FIG. 2 according to a second embodiment;

FIG. 9 is a flowchart of the same subject as that in FIG. 5 according to the second embodiment;

FIG. 10 is a diagram of the same subject as that in FIG. 2 according to a third embodiment; and

FIG. 11 is a flowchart of the same subject as that in FIG. 5 according to the third embodiment.

### DETAILED DESCRIPTION OF THE EMBODIMENTS

### <First Embodiment>

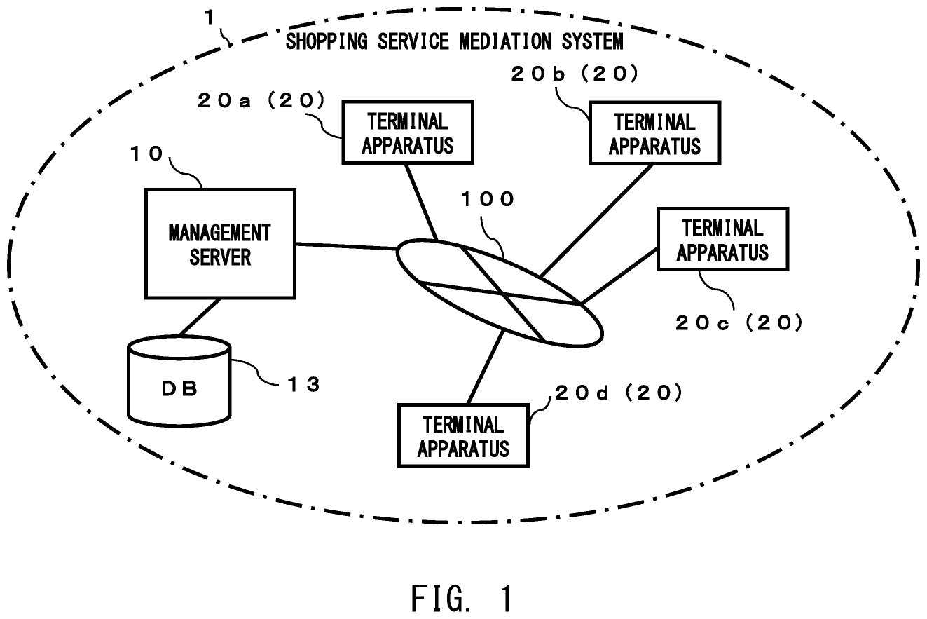

Referring to FIG. 1 to FIG. 7, a shopping service mediation system according to a first embodiment will be described. First, with reference to FIG. 1, an example of an overall configuration of the shopping service mediation system according to the first embodiment will be described.

### 1. Overall Configuration of Shopping Service Mediation System

As illustrated in FIG. 1, the shopping service mediation system 1 according to the first embodiment may include a management server 10, a database 13 that is accessible by the management server 10, and a plurality of terminal apparatuses 20. The management server 10 and each terminal apparatus 20 are allowed to perform data communication with each other, and the shopping service mediation system 1 may be built, for example, on the Internet 100. The terminal apparatus 20 conceptually includes a smartphone, a personal computer, a tablet terminal, or the like, each corresponding to each of a plurality of users and accepting input operations of each user. On the other hand, the management server 10 may be placed, for example, in a business office of a mediator that mediates shopping service or on a cloud, under the control of the mediator. Although four terminal apparatuses 20, i.e., a terminal apparatus 20a, a terminal apparatus 20b, a terminal apparatus 20c, and a terminal apparatus 20d, are illustrated in FIG. 1, the number of the terminal apparatuses 20 in the shopping service mediation system 1 is not limited to this number. The database 13 may be configured to be accessible to the management server 10 through the Internet 100. Hereinafter, when the terminal apparatuses 20a to 20d are not particularly distinguished, each of them will be referred to as the terminal apparatus 20. Furthermore, a user corresponding to the terminal apparatus 20a will be referred to as a user 20a, a user corresponding to the terminal apparatus 20b will be referred to as a user 20b, a user corresponding to the terminal apparatus 20c will be referred to as a user 20c, and a user corresponding to the terminal apparatus 20d will be referred to as a user 20d.

Incidentally, each of the management server 10 and the database 13 illustrated in FIG. 1 is a conceptual configuration, and then they may be physically realized as one apparatus, or may be physically realized by a plurality of apparatuses. For example, the database 13 may be provided in the management server 10. Furthermore, any one or more of the terminal apparatuses 20 may work as a part or all of the process and hardware configuration of the management server 10, thereby to realize the management server 10. Alternatively, all processes and a hardware configuration of the management server 10 may be distributed to the plurality of terminal apparatuses 20 to realize the management server 10.

### 2. Hardware Configuration of Management Server

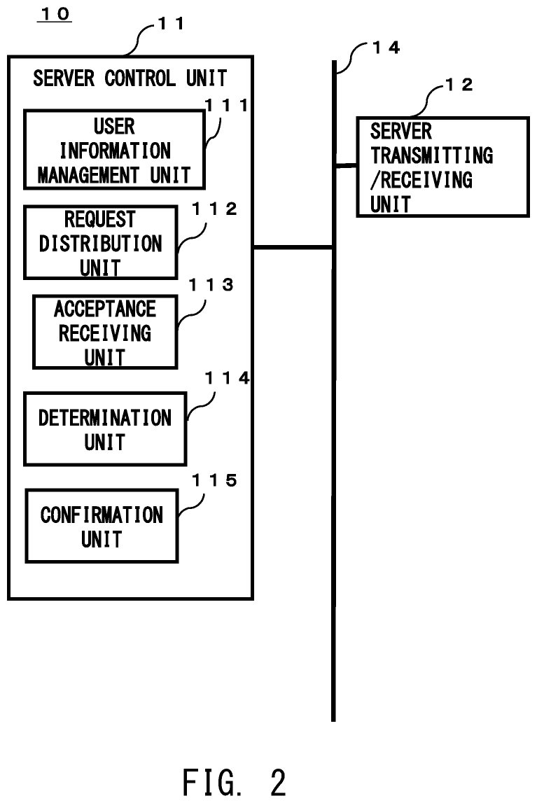

An example of a hardware configuration of the management server 10 will be described with reference to FIG. 2. Since the management server 10 is a conceptual one as described above, the hardware configuration illustrated in FIG. 2 and its operation may be realized, for example, by a plurality of server apparatuses. Alternatively, a part or all of the hardware configuration and its operation may be distributed and realized on at least a part of the terminal apparatuses 20.

The management server 10 may include, for example, a server control unit 11 and a server transmitting/receiving unit 12. The server control unit 11 and the server transmitting/receiving unit 12 are allowed to perform data communication with each other and may be connected to each other through a data bus 14, for example. Furthermore, the management server 10 may include, for example, a not-illustrated data input/output unit that accepts various operations of a system operation manager and that outputs various data to the system operation manager.

For example, the server transmitting/receiving unit 12 performs transmission and reception of various data with an external configuration of the management server 10 (e.g., each terminal apparatus 20) through the Internet 100. The server control unit 11 is configured to control each process performed by the management server 10. The server control unit 11 may be configured, for example, as a computer unit including a CPU (Central Processing Unit) and a storage area required for its operation: a RAM (Random Access Memory) and a ROM (Read Only Memory).

For example, the server control unit 11 may read and execute a computer program stored in the ROM. For example, the server control unit 11 may read a computer program stored in a non-volatile recording medium that is readable by a computer, by using a not-illustrated recording medium reading apparatus. The server control unit 11 may read a computer program from a not-illustrated apparatus that is located outside the management server 10 through the Internet 100. The server control unit 11 executes the read computer program. As a result, logical functional blocks for performing operations to be performed by the management server 10 are realized in the server control unit 11. That is, the server control unit 11 is configured to function as a controller for realizing the logical functional blocks for performing operations to be performed by the management server 10. FIG. 2 illustrates an example of the logical functional blocks realized in the server control unit 11. As illustrated in FIG. 2, for example, a user information management unit 111, a request distribution unit 112, an acceptance receiving unit 113, a determination unit 114, and a confirmation unit 115 may be realized in the server control unit 11. The operation of each of the units 111 to 115 will be described later.

### 3. Data Held by Database

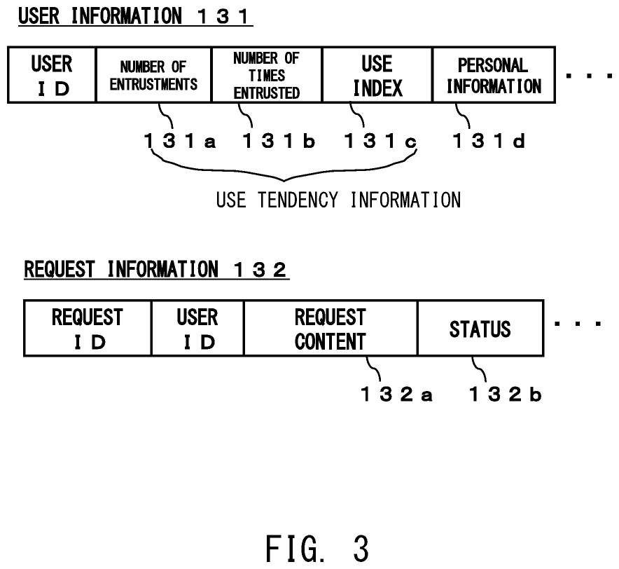

The database 13 holds various data required for various processes performed by the management server 10. As illustrated in FIG. 3, the database 13 may store therein, for example, user information 131, request information 132, and the like. In the user information 131, information with respect to each user who uses the shopping service mediation system 1 is registered. For example, as illustrated in FIG. 3, the user information 131 may be configured such that the number of entrustments 131a, the number of times entrusted 131b, a use index 131c, and personal information 131d are associated with a user ID for identifying each user. The number of entrustments 131a indicates information about the number of times that the user has entrusted shopping service in the past. The number of times entrusted 131b indicates information about the number of times that the user was entrusted with the shopping service in the past. In some embodiments, each Each f the number of entrustments 131a and the number of times entrusted 131b holds in addition to a cumulative number, time information with respect to entrustment or time entrusted, so that the number of times is counted in time series in an arbitrary totalization unit, such as a day, a month, or a year. The use index 131c is an index indicating a use tendency of the shopping service mediation system 1 with respect to the user (i.e., whether the user tends to be entrusted with the shopping service or tends to entrust the shopping service). The use index 131c may be set on the basis of a relationship between the number of entrustments 131a and the number of times entrusted 131b. The use index 131c may include, for example, a consignor degree, which is a ratio of the number of entrustments to the total of the number of entrustments and the number of times entrusted (hereinafter referred to as “the number of uses”), and a consignee degree, which is a ratio of the number of times entrusted to the number of uses. In addition, each of the consignor degree and the consignee degree may be indicated, for example, by a level value in which the degree is classified in stages. The number of entrustments 131a, the number of times entrusted 131b, and the use index 131c may be used to visualize and show the tendency of the use of the shopping agency mediation system 1 to the user. Hereinafter, the number of entrustments 131a, the number of times entrusted 131b, and the use index 131c will be referred to as use tendency information. The personal information 131d may include, for example, the user's name, address, and contact information that allows correspondence via the terminal apparatus 20, such as an email address, or the like.

The request information 132 holds information about shopping service to be entrusted, the request information 132 being information based on a request transmitted to the management server 10 by a user who wishes to entrust the shopping service (i.e., a consignor or a client). In the request information 132, for example, as illustrated in FIG. 3, the user ID of a user as the consignor, a request content 132a, a status 132b, and the like may be associated with a request ID for identifying each request. The request content 132a may include, for example, a purchase requested item (i.e., a target item of the shopping service), a desired number of purchased pieces, a desired deadline of receipt, a desired purchase location (e.g., store information), and the like. The status 132b indicates a current status of the corresponding request. The status may include, for example, “currently accepting” indicating that acceptance of a consignment applicant who wishes to be entrusted with the corresponding shopping service is ongoing, “determined” indicating that a formal consignee of the corresponding shopping service has been determined, and “service completed” indicating that the corresponding shopping service has been completed, or the like.

### 4. Operation of Server Control Unit

Returning to FIG. 2, the operation of each of the units 111 to 115 realized by the server control unit 11 will be described. Incidentally, the transmission and reception in each of the units 111 to 115 is transmission and reception via the server transmitting/receiving unit 12. The user information management unit 111 manages the registration and update of the user information 131. For example, the user information management unit 111 may accept the registration of a new user and store the user information 131 with respect to the new user. By this, the new user is registered as a user of the shopping service mediation system 1. Furthermore, the user information management unit 111 may update, for example, the number of entrustments 131a, the number of times entrusted 131b, and the use index 131c at each time when the shopping service is completed, and may display them on the terminal apparatus 20 at an appropriate time such that each user can recognize the use tendency of himself/herself.

The request distribution unit 112 distributes a request for shopping service. For example, when the request distribution unit 112 receives a request from the terminal apparatus 20 corresponding to the consignor of the shopping service, it may distribute the request to the terminal apparatuses 20 corresponding to users other than the consignor. For example, the acceptance receiving unit 113 may receive an acceptance indicating desire to undertake the request, from the terminal apparatus 20 that has received the request.

The determination unit 114 determines the formal consignee of the shopping service. For example, the determination unit 114 may determine as the formal consignee, a user who satisfies a predetermined condition, from among the users corresponding to the terminal apparatuses 20 that have transmitted the acceptance. After determining the formal consignee, for example, the determination unit 114 may transmit a notice of determination to each terminal apparatus 20 that has transmitted the acceptance. The confirmation unit 115 confirms the completion of the shopping service. For example, when receiving a notice of completion indicating that the shopping service has been completed by the formal consignee, the confirmation unit 115 may determine that the completion is confirmed.

### 5. Hardware Configuration of Terminal Apparatus

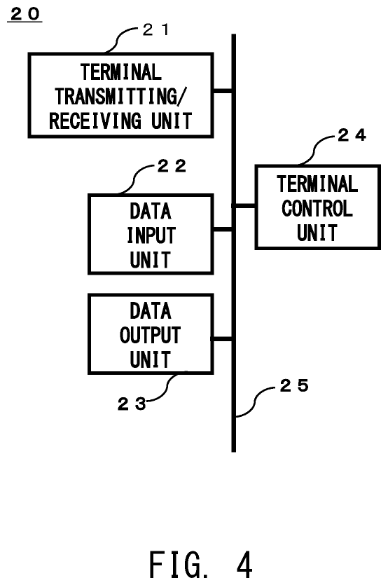

An example of a basic hardware configuration of the terminal apparatus 20 will be described with reference to FIG. 4. The terminal apparatus 20 may include, for example, a terminal transmitting/receiving unit 21, a data input unit 22, a data output unit 23, and a terminal control unit 24. The terminal transmitting/receiving unit 21, the data input unit 22, the data output unit 23, and the terminal control unit 24 may be connected to each other, for example, to allow data communication through a data bus 25. The terminal transmitting/receiving unit 21 may be configured, for example, to perform transmission and reception of various data with an external configuration of the terminal apparatus 20, such as the management server 10, through the Internet 100. The data input unit 22 may be configured, for example, to receive data input of various data from the user as an operator of the terminal apparatus 20. The data input includes, for example, input via various input devices such as a keyboard and a mouse, a non-contact input or a contact input with a touch panel or a button, an audio input, or the like. The data output unit 23 may be configured, for example, to output various data to the operator of the terminal apparatus 20. The data output includes a screen output, an audio output, or the like.

The terminal control unit 24 is configured to control each process in the terminal apparatus 20 by controlling operations of each of the other units 21, 22, and 23. The terminal control unit 24 may be configured as a computer unit including, for example, a CPU (Central Processing Unit) and a storage area required for its operations: a RAM (Random Access Memory) and a ROM (Read Only Memory). The terminal control unit 24 may function, for example, as a user interface of the management server 10. The terminal control unit 24 may allow the user to input data and may transmit the input data to the management server 10, for example, in accordance with an instruction from the management server 10. Furthermore, the terminal control unit 24 may obtain the data from the management server 10 and may output the obtained data to the user, for example, in accordance with an instruction from the management server 10. The terminal control unit 24 may be configured to realize at least a part of the above-described units 111 to 115 of the server control unit 11. For example, the terminal control unit 24 receives the request and the notice of determination or the like, and transmits the acceptance and the notice of completion or the like, via the terminal transmitting/receiving unit 21.

### 6. Process Performed by Shopping Service Mediation System

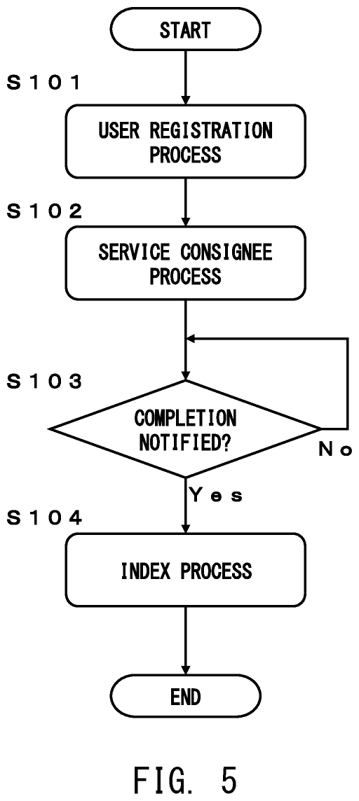

A process performed in the shopping service mediation system 1 will be described with reference to FIG. 5 to FIG. 7, centering on processes performed by the server control unit 11.

FIG. 5 is a flowchart illustrating an example of a processing routine with respect to mediation of shopping service performed by the shopping service mediation system 1. First, the server control unit 11 performs a user registration process (step S101). The user registration process includes a step of registering a user who uses the shopping service mediation system 1. The user registration process may be performed, for example, by the user information management unit 111. For example, when a user who wishes to register in the shopping service mediation system 1 transmits a registration request to the management server 10, the user information management unit 111 may perform the user registration process in response to the registration request received. As the user registration process, for example, the user information management unit 111 may assign the user ID to the user who wishes the registration, may obtain the personal information 131d, such as the user's name and address, via the terminal apparatus 20, and may set the obtained personal information 131d in the user information 131 in association with the user ID.

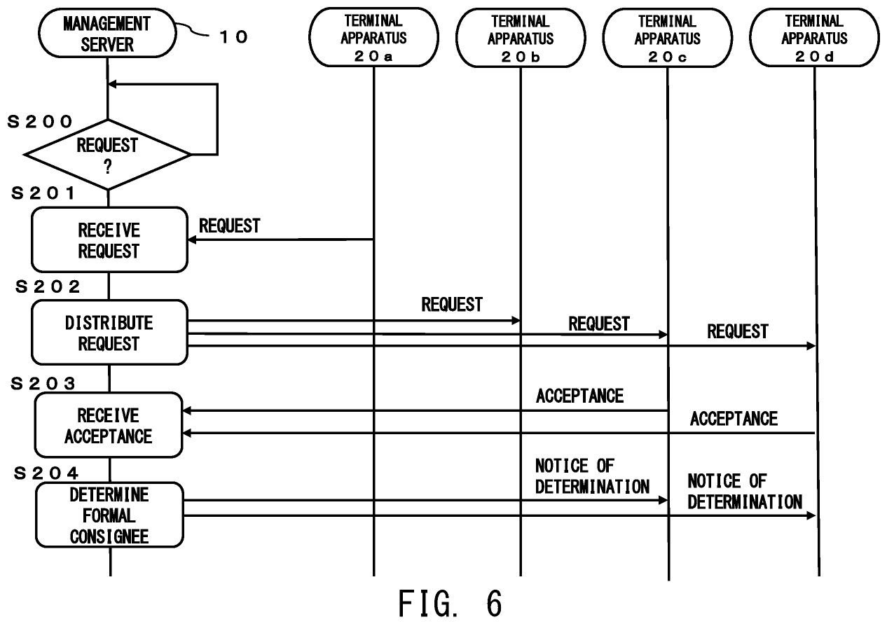

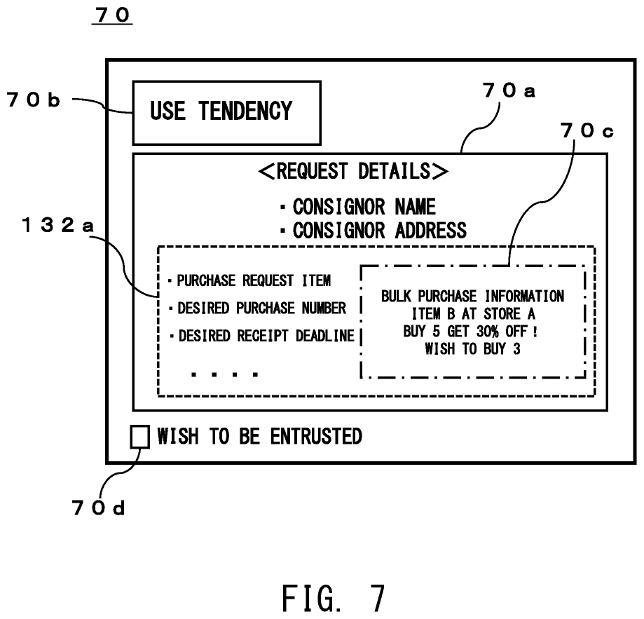

Subsequently, the server control unit 11 may perform a service consignee process (step S102). The service consignee process includes a step of receiving shopping service to be entrusted to a step of determining the formal consignee. The service consignee process will be described with reference to FIG. 6 and FIG. 7. In the following explanation, processes performed by the management server 10 are processes performed under the control of the server control unit 11.

The management server 10 is in a reception waiting state for waiting for the reception of a request to entrust shopping service (step S200). When the request is transmitted from the terminal apparatus 20 (the terminal apparatus 20a in the first embodiment) to the management server 10 (the step S200: Yes), the management server 10 receives the request (step S201). The request may include, for example, information indicating the user ID of the user (the user 20a of the terminal apparatus 20a in the first embodiment) as the consignor of the shopping service, the request content 132a for the shopping service (i.e., the purchase request item, the desired number of purchased pieces, the desired deadline of receipt, the desired purchase location, etc.), or the like.

For example, the management server 10 that has received the request may assign the request ID to the received request and may generate the request information 132 with respect to the received request. When generating the request information 132, for example, the management server 10 may set the status 132b at this stage to “currently accepting”. Subsequently, the management server 10 may distribute the request received from the terminal apparatus 20a, to all the terminal apparatuses 20 in the shopping service mediation system 1 excluding the terminal apparatus 20a (step S202). In the first embodiment, the managing server 10 distributes the request including the request content 132a to the terminal apparatuses 20b to 20d. The distributed request may include, for example, the user ID and the request ID corresponding to the request.

At the terminal apparatus 20 that has received the request from the management server 10, for example, a request screen 70 as illustrated in FIG. 7 may be displayed in accordance with the user's operation. The displayed request screen 70 allows the user to check the content of the shopping service and to examine whether or not to be entrusted with the shopping service. The request screen 70 may display, for example, the consignor's name, the consignor's address, and the request content 132a as request details 70a. At this stage, the consignor's name and the consignor's address are desirably displayed such that the name and address are not specified, from the viewpoint of the Personal Information Protection Law. Furthermore, for example, when distributing the request to each terminal apparatus 20, the management server 10 may also transmit the use tendency information with respect to the user corresponding to the terminal apparatus 20 to display it as a use tendency 70b on the request screen 70. This allows the visualization of the user's use tendency and allows the user to visually recognize his/her use tendency.

The use tendency 70b may be displayed in such a way as to allow the user to recognize the user's own use tendency or lead the user to recognize the user's use tendency. As the display state of the use tendency 70b, for example, numerical values held by the number of entrustments 131a and the number of times entrusted 131b and/or the use index 131c may be displayed as they are, or a statistical value based on a predetermined statistical method may be displayed. Alternatively, the display state of the use tendency 70b may be a graph, a table, a gauge, or the like. For example, the use tendency 70b may be illustrated in such a way that the consignor degree and the consignee degree are colored differently from each other such that the use tendency is recognized by the density of each color. Furthermore, the use tendency 70b may indicate the use tendency of a predetermined period (e.g., the last 6 months) or of a period designated by the user. For example, the use tendency 70b may be graphically represented, like a monthly summary graph for the last six months, on the basis of the numerical values held by the number of entrustments 131a and the number of times entrusted 131b and/or the use index 131c. Since the use tendency 70b is displayed on the request screen 70, the user can determine whether or not to undertake the displayed request after confirming not only the request content but also his/her own use tendency.

The request screen 70 may further display bulk purchase information 70c indicating information about a bulk purchase discount, as illustrated in FIG. 7. The bulk purchase information 70c may show, for example, discount information (e.g., a target item, a required number of pieces to be purchased, a discount rate, etc.), store information (e.g., the store name and the store location) of a store that provides the bulk purchase discount, and the number of pieces that the consignor wishes to buy, as the information about the bulk purchase discount of the target item of the shopping service. In the example illustrated in FIG. 7, the bulk purchase information 70c shows that the consignor wishes to buy three pieces of the target item B on which a 30% discount is provided when buying five pieces at a store A. In this case, the bulk purchase information 70c means that if two more pieces of the target item B are purchased together at the store A, the bulk purchase discount will be applied and the 30% discount will be provided to the target item B. Therefore, for a user who wishes to purchase the target item B and who can go shopping at the store A, it is possible to increase the user's motivation of undertaking the displayed request.

The bulk purchase information 70c may be displayed on the request screen 70, for example, by being included in the request content 132a of the request transmitted from the consignor by the consignor's input operation. Alternatively, the bulk purchase information 70c may be displayed on the request screen 70 in the following manner; the management server 10 may cooperate with a not-illustrated store system to obtain from the store system the bulk purchase information about the purchase request item indicated by the request, and then may include the obtained bulk purchase information in the request content 132a of the request for distributing the bulk purchase information.

The user who wishes to undertake the displayed request may, for example, check a check box 70d of “wish to be entrusted”. By this, the acceptance indicating desire to be entrusted is transmitted to the management server 10. As described above, the acceptance may be transmitted from the terminal apparatus 20 in response to the operation of the user who wishes to be entrusted with the shopping service (i.e., the consignment applicant). The acceptance may include, for example, the request ID of the request the consignment applicant wishes to undertake, and the user ID of the consignment applicant.

After distributing the request, the management server 10 allows the acceptance from the terminal apparatus 20 to be received within a predetermined acceptance limit, for example (step S203). The acceptance limit may be, for example, a time limit or an upper limit of the number of acceptances received. In the first embodiment, out of the terminal apparatuses 20b to 20d that have received the request, the acceptance is transmitted from the terminal apparatus 20c and the terminal apparatus 20d, and these acceptances are received by the management server 10. This indicates that the user 20c of the terminal apparatus 20c and the user 20d of the terminal apparatus 20d each have transmitted the acceptance, as the consignment applicant of the shopping service.

Subsequently, the management server 10 determines as the formal consignee the user who satisfies the predetermined condition, from the consignment applicants (step S204). For example, when receiving only one acceptance, i.e., when there is only one consignment applicant, the management server 10 may determine the consignment applicant as the formal consignee. When receiving two or more acceptances, i.e., when there are two or more consignment applicants, the management server 10 may determine the formal consignee, for example, in order of arrival. Alternatively, the management server 10 may determine the consignment applicant whose address is the closest to that of the consignor, as the formal consignee. Alternatively, the management server 10 may determine the user having the lowest consignee degree (or consignee level) as the formal consignee, by referring to the use index 131c of each consignment applicant.

After determining the formal consignee, the management server 10 may transmit the notice of determination to each of the terminal apparatuses 20 of the consignment applicants, each terminal apparatus 20 having transmitted the acceptance. In the first embodiment, the management server 10 transmits the notice of determination to the terminal apparatus 20c and the terminal apparatus 20d, both terminal apparatuses 20c and 20d having transmitted the acceptance. For example, when the user 20c of the terminal apparatus 20c is determined as the formal consignee, the notice of determination transmitted to the terminal apparatus 20c may indicate that the user 20c is determined as the formal consignee. Furthermore, the notice of determination transmitted to the user determined as the formal consignee may include information that allows the consignor's name and address to be specified. On the other hand, the notice of determination transmitted to the terminal apparatus 20d of the user 20d, which is not determined as the formal consignee, may indicate that the user 20d is not determined as the formal consignee. Furthermore, after determining the formal consignee, the management server 10 may update the status 132b of the corresponding request to “determined”.

The processes in the step S201 and the step S202 are performed by the request distribution unit 112 of the server control unit 11. The process in the step S203 is performed by the acceptance receiving unit 113 of the server control unit 11. The process in the step S204 is performed by the determination unit 114 of the server control unit 11.

Returning to FIG. 5, after the service consignee process (the step S102), for example, the server control unit 11 may be in a reception waiting state of waiting for the notice of completion indicating the completion of the shopping service (step S103). For example, the notice of completion may be transmitted to the management server 10 from the terminal apparatus 20 (the terminal apparatus 20a in the first embodiment) in accordance with operation performed by the consignor (the user 20a in the first embodiment) who has received the purchase request item with respect to the shopping service. Alternatively, for example, the notice of completion may be transmitted to the management server 10 from the terminal apparatus 20 (the terminal apparatus 20c in the first embodiment) in accordance with operation performed by the formal consignee (the user 20c in the first embodiment) when the purchase request item with respect to the shopping service is passed to the consignor (the user 20a in the first embodiment).

After receiving the notice of completion (the step S103: Yes), for example, the server control unit 11 may perform an index process (step S104). In the index process, the user data 131 is updated. For example, the user information management unit 111 of the server control unit 11 updates the number of entrustments 131a of the consignor (the user 20a in the first embodiment) (e.g., counts up the total number of entrustments and adds the completion date of the shopping service to the time information), and updates the use index 131c of the user 20a in association with the update. Furthermore, the user information management unit 111 updates the number of times entrusted 131b of the formal consignee (the user 20c in the first embodiment) (e.g., counts up the total number of times entrusted and adds the completion date of the shopping service to the time information), and updates the use index 131c of the user 20c in association with the update. In addition, after receiving the notice of completion, for example, the server control unit 11 may set the status 132b of the corresponding request to “service completed”.

Then, the processing routine for the mediation of shopping service is ended. In a condition in which there is the user information 131 with respect to a plurality of users, the server control unit 11 may perform the processes at and after the step S102 as another processing routine independent of the user information registration process of the step S101.

The use tendency 70b may be displayed not only on the request screen 70 but also on the terminal apparatus 20 at an appropriate time. For example, in response to a display requesting operation to the terminal apparatus 20 by the user, his/her use tendency 70b may be displayed at the time. This makes it possible for the user to confirm his/her (i.e. the user's) own use tendency 70b at an arbitrary time. Furthermore, the user's use tendency 70b may be displayed on a screen on which the user as the consignor makes an entrustment with respect to shopping service. This allows the user to recognize his/her own use tendency 70b and then determine to entrust the shopping service. As described above, it is possible to by allowing each user to recognize the user's own use tendency 70b at an appropriate time, lead the user such that the user's use tendency does not lean to the consignor or the consignee. In the shopping service mediation system 1, the user information 131 may not include the use index 11c, and the information indicated by the use index 131c may be appropriately calculated and derived on the basis of the number of entrustments 131a and the number of times entrustments 131b.

The personal information 131d in the user information 131 may include, for example, the user's age or generation. In this case, for example, the user information management unit 111 may make a group of users by age or generation, and may perform the service consignee process (FIG. 5: the step S102) to the index process (FIG. 5: the step S104), for each group. Since the users of the same age or generation wish to buy or use similar items, it is possible to provide an environment in which the users can feel free to entrust shopping service or to be entrusted with the shopping service.

When there are two or more requests whose status 132b of the request information 132 is “currently accepting”, for example, the request distribution unit 112 may display a list of the “currently accepting” requests on the terminal apparatus 20 for the user to select one of the requests, and may display the request screen 70 (FIG. 7) with respect to the request requested. Furthermore, when the list is displayed on the terminal apparatus 20, for example, the terminal control unit 24 may perform a display control such that the list of the requests is displayed in a format in which the requests are classified by kinds of items or by stores where the items can be purchased, on the basis of the purchase request item indicated by each request. In this case, for example, the terminal control unit 24 may specify the store where the purchase request item indicated by each request can be purchased, on the basis of a store list on which an item and a store in which the item can be purchased are associated with each other. The store list may be held by the management server 10 or by each terminal apparatus 20. Furthermore, for example, the terminal control unit 24 may specify a store indicated as the desired purchase location in the request content 132a, as “the store in which the purchase request item can be purchased”.

As described in detail above, according to the first embodiment, by visualizing and showing to the user the use tendency of the shopping service in the past, it is possible to lead to balance between the number of entrustments and the number of times entrusted of an individual user, or fairness between the service use and the assistance.

### <Second Embodiment>

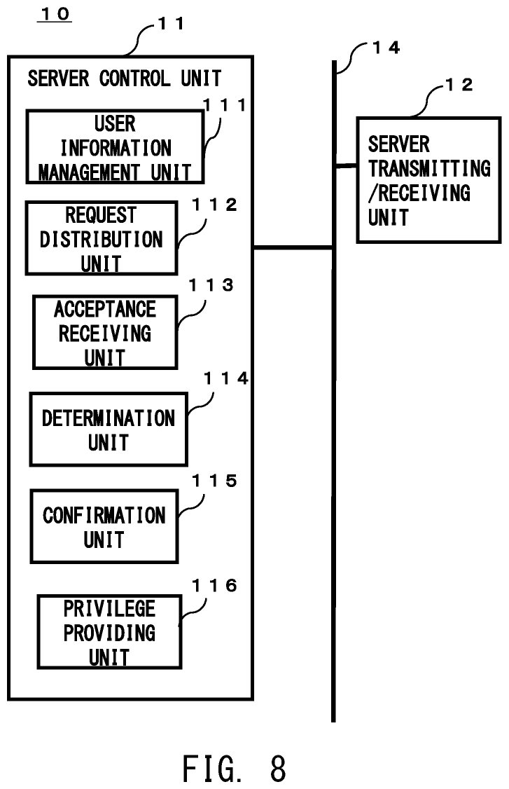

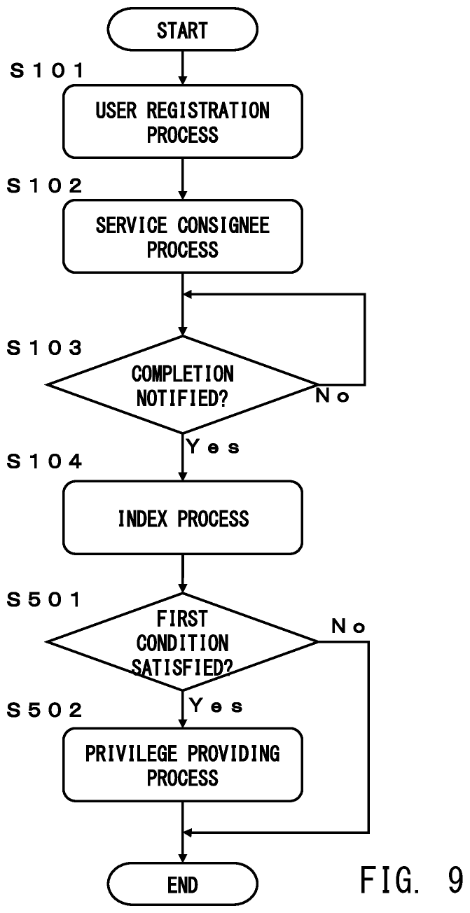

Referring to FIG. 8 and FIG. 9, a description will be given to a second embodiment. FIG. 8 is a diagram of the same subject as that in FIG. 2 according to the first embodiment, and FIG. 9 is a diagram of the same subject as that in FIG. 5. In FIG. 8 and FIG. 9, the same components as those in the first embodiment illustrated in FIG. 2 and FIG. 5 carry the same reference numerals, and their description will be omitted as appropriate. The second embodiment is configured such that privilege is granted to a user for whom the relationship between the number of entrustments and the number of times entrusted satisfies a first condition (hereinafter referred to as a “target user” in the second embodiment). The privilege to be granted may be, for example, a discount privilege at a specific store, a present privilege at a specific store, or the like.

As illustrated in FIG. 8, the server control unit 11 further includes a privilege providing unit 116. For example, the privilege providing unit 116 may grant a privilege to the target user and may add information about the privilege to the personal information 131d on the target user. The first condition may be set such that the privilege is granted to the user who is entrusted more often than makes an entrustment. For example, the first condition includes that the number of times entrusted within a predetermined period is greater than the number of entrustments and its difference is greater than or equal to a predetermined criterion, or, that the consignee degree (or consignee level) is greater than or equal to a predetermined criterion, or the like.

The process performed by the privilege providing unit 116 will be described. For example, as illustrated in FIG. 9, after the user information 131 is updated in the index process (the step S104), the privilege providing unit 116 may determine whether or not the relationship between the number of entrustments and the number of times entrusted with respect to the user who is the formal consignee satisfies the first condition (step S501). The privilege providing unit 116 may refer to the number of entrustments 131a, the number of times entrusted 131b, and/or the use index 131c for the determination. When the relationship does not satisfy the first condition (the step S501: No), the privilege providing unit 116 may end the processing routine corresponding to the shopping service of the ongoing processing. On the other hand, when the relationship satisfies the first condition (the step S501: Yes), the privilege providing unit 116 performs a privilege providing process (step S502), and then may end the processing routine corresponding to the shopping service of the ongoing processing.

As described above, in the step S502, the privilege providing unit 116 may perform the privilege providing process of granting the privilege to the target user. As the privilege providing process, for example, the privilege providing unit 116 may issue a privilege coupon indicating the privilege to the target user and may set the privilege coupon in the personal information 131d on the target user. The privilege coupon may indicate, for example, privilege content and a store in which the privilege is provided (hereinafter referred to as a “target store”). For example, the privilege providing unit 116 may notify the target user that the privilege has been granted.

For example, the target user can receive the privilege at the target store by printing the provided privilege coupon or displaying it on a screen. For example, in the case of the discount privilege, the target user may be provided with a discount for purchasing an item at the target store. Alternatively, in the case of the present privilege, the target user may be provided with a predetermined item as a present at the target store. As described above, according to the second embodiment, by granting the privilege to the user who assists often, it is possible to fill an imbalance between the service use and the assistance with economic value.

### <Third Embodiment>

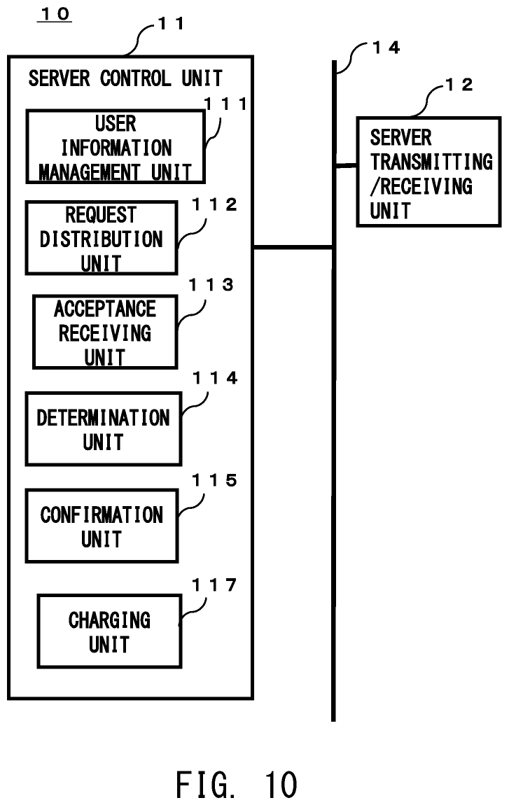

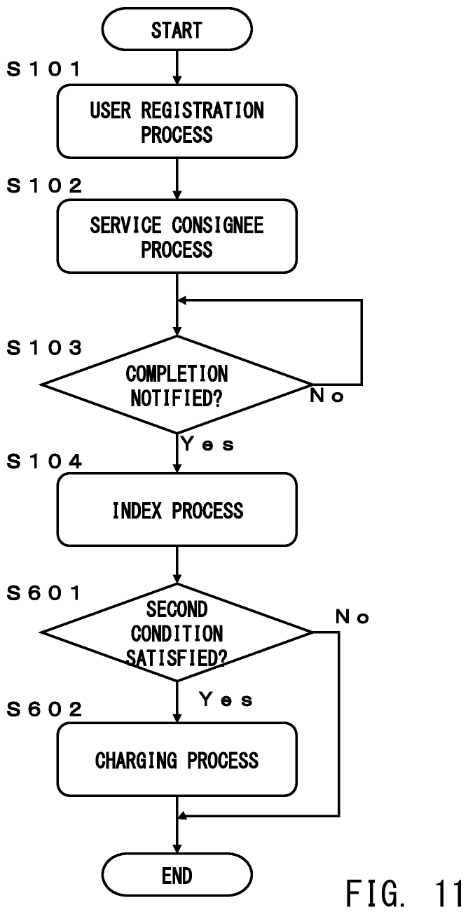

Referring to FIG. 10 and FIG. 11, a description will be given to a third embodiment. FIG. 10 is a diagram of the same subject as that in FIG. 2 according to the first embodiment, and FIG. 11 is a diagram of the same subject as that in FIG. 5. In FIG. 10 and FIG. 11, the same components as those in the first embodiment illustrated in FIG. 2 and FIG. 5 carry the same reference numerals, and their description will be omitted as appropriate. The third embodiment is configured such that a usage fee of the shopping service mediation system 1 (hereinafter referred to as a “system usage fee”) is charged to a user for whom the relationship between the number of entrustments and the number of times entrusted satisfies a second condition (hereinafter referred to as a “target user” in the third embodiment).

As illustrated in FIG. 10, the server control unit 11 further includes a charging unit 117. For example, the charging unit 117 may charge the system usage fee to the target user and may add information indicating the charging of the system usage fee to the personal information 131d on the target user. The second condition may be set so as to charge the system usage fee to the user who makes an entrustment more often than is entrusted. For example, the second condition includes that the number of entrustments within a predetermined period is greater than the number of times entrusted and its difference is greater than or equal to a predetermined criterion, or, that the consignor degree (or consignor level) is greater than or equal to a predetermined criterion, or the like.

The process performed by the charging unit 117 will be described. For example, as illustrated in FIG. 11, after the user information 131 is updated in the index process (the step S104), the charging unit 117 may determine whether or not the relationship between the number of entrustments and the number of times entrusted with respect to the user who is the consignor satisfies the second condition (step S601). The charging unit 117 may refer to the number of entrustments 131a, the number of times entrusted 131b, and/or the use index 131c for the determination. When the relationship does not satisfy the second condition (the step S601: No), the charging unit 117 may end the processing routine corresponding to the shopping service of the ongoing processing. On the other hand, when the relationship satisfies the second condition (the step S601: Yes), the charging unit 117 performs a charging process (step S602), and then may end the processing routine corresponding to the shopping service of the ongoing processing.

As described above, the charging unit 117 may perform the charging process of charging the system usage fee to the target user in the step S602. As the charging process, for example, the charging unit 117 may charge the system usage fee whose amount corresponds to the relationship, to the target user. For example, the system usage fee may be set in proportion to the difference between the number of entrustments and the number of times entrusted. For example, the charging unit 117 may notify the target user that the target user is a charging target of the system usage fee. For example, the charging unit 117 may add the charged system usage fee to the personal data 131d on the target user and may end the corresponding processing routine, and may charge the system usage fee when the target user re-accesses the shopping service mediation system 1. Alternatively, in the charging process in the step S602 of the corresponding processing routine, the charging unit 117 may charge the system usage fee which has occurred to the target user.

For example, the charging unit 117 may be configured to prohibit the target user from using the shopping service mediation system 1 until the payment of the charged system usage fee is confirmed via a not-illustrated financial organization system, and to allow the target user to use the shopping service mediation system 1 after the payment is confirmed. As described above, according to the third embodiment, by charging the system usage fee to the user who assists less often, it is possible to fill an imbalance between the service use and the assistance with economic value.

### <Supplementary Notes>

With respect to the embodiments described above, the following Supplementary Notes are further disclosed.

### Supplementary Note 1

A shopping service mediation system described in Supplementary Note 1 according to embodiments of the present disclosure is a shopping service mediation system that mediates shopping service between a consignor who entrusts the shopping service and a consignee who is entrusted with the shopping service, the shopping mediation system including terminal apparatuses corresponding to a plurality of users respectively and comprising: a user information management unit configured to manage user information that is information with respect to each of the plurality of users that can be at least one of the consignor and the consignee; a request distribution unit configured to distribute a request from the terminal apparatus related to a user as the consignor out of the plurality of users, to the terminal apparatuses related to users other than the consignor out of the plurality of users; an acceptance receiving unit configured to receive at least one acceptance, the acceptance indicating a desire to be entrusted with the shopping service, and having being transmitted from the terminal apparatus in response to the request distributed; a determination unit configured to determine a formal consignee from the users related to the terminal apparatuses each having transmitted the acceptance; and a confirmation unit configured to confirm completion of the shopping service by the formal consignee, wherein the user information management unit is configured to update a number of entrustments included in the user information with respect to the consignor and to update a number of times entrusted included in the user information with respect to the formal consignee when the completion of the shopping service is confirmed by the confirmation unit, and the user information management unit is further configured to display each user's use tendency based on the number of entrustments and the number of times entrusted, on the terminal apparatus corresponding to the user.

According to the shopping service mediation system described in Supplementary Note 1, the consignor and the consignee of the shopping service are matched and the shopping service is realized. At the same time, the number of entrustments and the number of times entrusted of each user are managed, and the “use tendency” based on the number of entrustments and the number of times entrusted can be displayed to each user. The “use tendency” is information indicating a tendency of the use of the shopping service mediation system obtained on the basis of the number of entrustments and the number of times entrusted with respect to the corresponding user.

Visualizing and showing this “use tendency” to the user allows each user to recognize whether the user has a tendency to entrust the shopping service more often or has a tendency to be entrusted more often. By this, it is possible to lead to balance between the number of entrustments and the number of times entrusted of an individual user, or fairness between the service use and the assistance, even in an environment where the shopping service is provided for free. In particular, it is effective to obtain the fairness in an environment where there is no payment or money transaction of a usage fee. Incidentally, “use tendency” may be information derived only by the number of entrustments and the number of times entrusted, or may be information derived by adding another information to the number of entrustments and the number of times entrusted.

### Supplementary Note 2

A shopping service mediation system described in Supplementary Note 2 according to embodiments of the present disclosure is the shopping service mediation system described in Supplementary Note 1, further comprising a privilege providing unit configured to grant a privilege to be provided at a particular store, to the user for whom a relationship between the number of entrustments and the number of times entrusted satisfies a first condition.

According to the shopping service mediation system described in Supplementary Note 2, for example, since the privilege can be granted to a user who is entrusted more often than makes an entrustment, it is possible to increase the motivation of being entrusted with the shopping service. The privilege may include, for example, an item discount privilege, a present privilege, or the like. By this, it is possible to fill an imbalance between the service use and the assistance with economic value.

### Supplementary Note 3

A shopping service mediation system described in Supplementary Note 3 according to embodiments of the present disclosure is the shopping service mediation system described in Supplementary Note 1, further comprising a charging unit configured to charge a system usage fee to the user for whom a relationship between the number of entrustments and the number of times entrusted satisfies a second condition.

According to the shopping service mediation system described in Supplementary Note 3, for example, the system usage fee can be charged to the user who makes an entrustment more often than is entrusted. By this, it is possible to fill an imbalance between the service use and the assistance with economic value. In addition, for example, it is possible to provide an environment where it is easy to participate in the system for a user who has a problem going out and thus is hardly entrusted with the shopping service, without making the user feel inferior to the other users.

### Supplementary Note 4

A shopping service mediation system described in Supplementary Note 4 according to embodiments of the present disclosure is the shopping service mediation system described in Supplementary Note 1, wherein the request includes: discount information with respect to a bulk purchase discount to be provided for an item that is a target of the shopping service; and store information indicating a store that provides the bulk purchase discount.

According to the shopping service mediation system described in Supplementary Note 4, for the item that is the target of the bulk purchase discount, the request includes the discount information on the discount and the store information on the store that provides the discount, and it is thus possible to display information about the bulk purchase discount on the terminal apparatus. Therefore, the user who is thinking about being entrusted with the shopping service can know the information about the bulk purchase discount. This provides an environment where the benefit of bulk purchase discount can be enjoyed by the consignor and the consignee. Incidentally, the information about a bulk purchase (the discount information and the store information, etc.) may be provided by the user or may be provided from the store.

### Supplementary Note 5

A shopping service mediation system described in Supplementary Note 5 according to embodiments of the present disclosure is the shopping service mediation system described in Supplementary Note 1, wherein the terminal apparatus is configured to display a plurality of the requests in a format in which the plurality of the requests are classified by kinds of items each being a target of the shopping service, or by stores where the items can be purchased.

According to the shopping service mediation system described in Supplementary Note 5, when the user views a plurality of requests on the terminal apparatus, the user can see them in the format in which the requests are classified by kinds of the items that are the targets of the shopping service, or by the stores where the items can be purchased. Therefore, it is possible to provide an environment where it is easy to search for a desired request from a plurality of requests, to the user who is thinking about being entrusted with the shopping service.

The present disclosure may be embodied in other specific forms without departing from the spirit or characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A shopping service mediation system that mediates shopping service between a consignor who entrusts the shopping service and a consignee who is entrusted with the shopping service, the shopping mediation system including terminal apparatuses corresponding to a plurality of users respectively and comprising:
a user information management unit configured to manage user information that is information with respect to each of the plurality of users that can be at least one of the consignor and the consignee;
a request distribution unit configured to distribute a request from the terminal apparatus related to a user as the consignor out of the plurality of users, to the terminal apparatuses related to users other than the consignor out of the plurality of users;
an acceptance receiving unit configured to receive at least one acceptance, the acceptance indicating a desire to be entrusted with the shopping service, and having being transmitted from the terminal apparatus in response to the request distributed;
a determination unit configured to determine a formal consignee from the users related to the terminal apparatuses each having transmitted the acceptance; and
a confirmation unit configured to confirm completion of the shopping service by the formal consignee, wherein
the user information management unit is configured to update a number of entrustments included in the user information with respect to the consignor and to update a number of times entrusted included in the user information with respect to the formal consignee when the completion of the shopping service is confirmed by the confirmation unit, and the user information management unit is further configured to display each user's use tendency based on the number of entrustments and the number of times entrusted, on the terminal apparatus corresponding to the user.

2. The shopping service mediation system according to claim 1, further comprising a privilege providing unit configured to grant a privilege to be provided at a particular store, to the user for whom a relationship between the number of entrustments and the number of times entrusted satisfies a first condition.

3. The shopping service mediation system according to claim 1, further comprising a charging unit configured to charge a system usage fee to the user for whom a relationship between the number of entrustments and the number of times entrusted satisfies a second condition.

4. The shopping service mediation system according to claim 1, wherein the request includes: discount information with respect to a bulk purchase discount to be provided for an item that is a target of the shopping service; and store information indicating a store that provides the bulk purchase discount.

5. The shopping service mediation system according to claim 1, wherein the terminal apparatus is configured to display a plurality of the requests in a format in which the plurality of the requests are classified by kinds of items each being a target of the shopping service, or by stores where the items can be purchased.
